(19) United States
(12) Patent Application Publication
(10) Pub. No.: US 2020/0063800 A1
(43) Pub. Date: Feb. 27, 2020

(54) FIXING APPARATUS FOR FIXING A SHAFT TO A MOUNTING PART AND ACTUATOR OF A ROBOT

(71) Applicant: Flexiv Ltd., Santa Clara, CA (US)

(72) Inventors: Shiquan Wang, Foster City, CA (US); Ran An, San Jose, CA (US)

(21) Appl. No.: 16/545,215

(22) Filed: Aug. 20, 2019

Related U.S. Application Data
(60) Provisional application No. 62/721,322, filed on Aug. 22, 2018.

(51) Int. Cl. F16D 1/096; B25J 9/12

(52) U.S. Cl. CPC F16D 1/096; B25J 9/126

(57) ABSTRACT

A fixing apparatus for fixing a shaft to a mounting part and an actuator of a robot are provided. The fixing apparatus includes an inner ring and an outer ring. The inner ring has an outer tapered surface and is arranged to be sleeved on the shaft. The outer ring has an inner tapered surface that fits the outer tapered surface of the inner ring. The inner ring and the outer ring are both arranged to abut the mounting part in an axial direction of the shaft. The outer ring is configured to be detachably fixed to the mounting part, and the inner ring is squeezed by the outer ring to grip the shaft in a radial direction when the outer ring is fixed to the mounting part.

### CROSS-REFERENCE TO RELATED APPLICATIONS

The present application claims the benefit of priority under 35 U.S.C § 119(e) to U.S. Provisional Patent Application Ser. No. 62/721,322, entitled “ROBUST AND RELEASABLE SHAFT FIXTURE WITH HIGH COMPACTNESS” and filed on Aug. 22, 2018, the disclosures of which are herein incorporated by reference in their entirety.

### TECHNICAL FIELD

The present disclosure generally relates to a shaft fixture structure, and in particular to a fixing apparatus for fixing a shaft to a mounting part and an actuator of a robot.

### BACKGROUND

Shaft locking fixtures are broadly used to fix parts to a shaft and prevent them from being moved by axial forces or moments. Common solutions include the shaft locking nut and the shaft collar. However, shaft locking nuts require a long enough thread for good engagement and a set screw feature for thread slip prevention, thus making them usually bulky and heavy. Shaft collars may be simpler, but can cause uneven force distribution on the shaft.

### SUMMARY

The present disclosure provides for a fixing apparatus for fixing a shaft to a mounting part and an actuator of a robot.

To solve the above-mentioned problem, the present disclosure adopts a technical scheme to provide a fixing apparatus for fixing a shaft to a mounting part. In some aspects of the present disclosure, the fixing apparatus may include an inner ring and an outer ring. The inner ring has an outer tapered surface and is capable of being sleeved on the shaft. The outer ring has an inner tapered surface that fits the outer tapered surface of the inner ring. The inner ring and the outer ring are both configured to abut the mounting part in an axial direction of the shaft. The outer ring is configured to be detachably fixed to the mounting part, and the inner ring is squeezed by the outer ring to grip the shaft in a radial direction when the outer ring is fixed to the mounting part.

In another aspect, the fixing apparatus may include an inner ring and an outer ring. The inner ring has an outer tapered surface and is capable of being sleeved on the shaft. The outer ring has an inner tapered surface that fits the outer tapered surface of the inner ring. The inner ring has an inner diameter originally smaller than the outer diameter of the shaft. When the outer ring is moved towards the mounting part and both the inner ring and the outer ring abut the mounting part in an axial direction of the shaft, the inner tapered surface of the outer ring squeezes the outer tapered surface of the inner ring to make the inner ring compress and grip the shaft. The outer ring is then detachably fixed to the mounting part.

To solve the above-mentioned problem, another technical scheme adopted by the present disclosure is to provide an actuator of a robot. The actuator includes a shaft, a mounting part and a fixing apparatus. The fixing apparatus is configured to fix the shaft to the mounting part. The fixing apparatus includes an inner ring and an outer ring. The inner ring has an outer tapered surface and is sleeved on the shaft. The outer ring has an inner tapered surface that fits the outer tapered surface of the inner ring. The inner ring and the outer ring both abut the mounting part in an axial direction of the shaft. The outer ring is detachably fixed to the mounting part, and the inner ring is squeezed by the outer ring to grip the shaft in a radial direction.

The present disclosure provides for fixing the shaft to the mounting part with high mounting precision, high clamping forces and easy installation procedures.

### BRIEF DESCRIPTION OF THE DRAWINGS

In order to clearly explain the technical solutions in the embodiments of the present disclosure, the drawings used in the description of the embodiments will be briefly described below. The drawings in the following description are merely exemplary embodiments of the present disclosure. For those of ordinary skill in the art, other embodiments may also be derived based on these drawings without any creative work.

FIG. 1 illustrates a schematic diagram of a fixing apparatus in a locked state, according to an embodiment of the present disclosure.

FIG. 2 illustrates a schematic diagram of a fixing apparatus in an unlocked state, according to an embodiment of the present disclosure.

FIGS. 3-6 show different exemplary structures of an inner ring of a fixing apparatus, according to some embodiments of the present disclosure.

FIG. 7 shows a schematic diagram of an actuator of a robot, according to an embodiment of the present disclosure.

### DETAILED DESCRIPTION

The disclosure will now be described in detail with reference to the accompanying drawings and examples. The described embodiments are merely exemplary and represent a subset of the embodiments of the present disclosure. One skilled in the art may recognize additional embodiments based on the embodiments of the present disclosure without creative efforts and all such embodiments fall within the scope of the present disclosure.

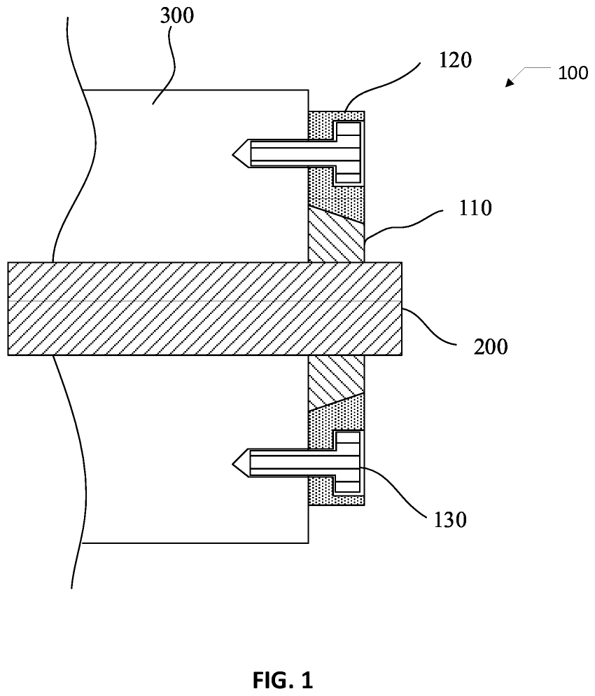

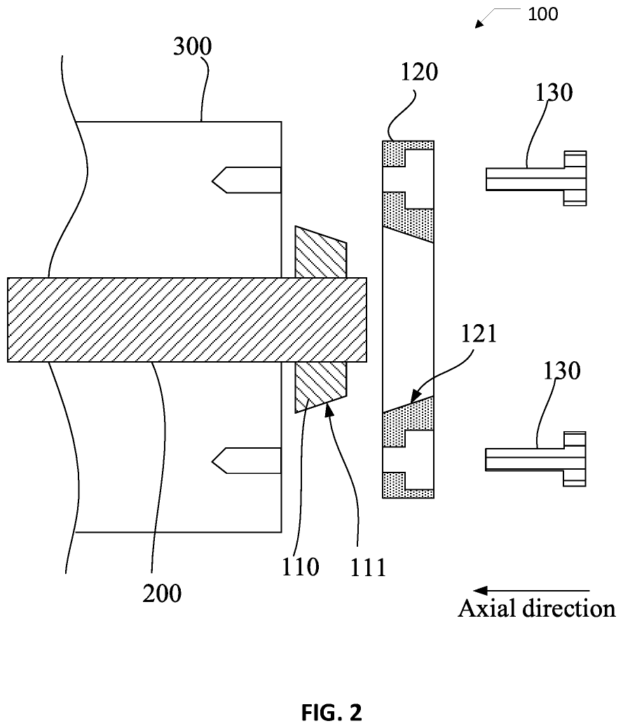

FIGS. 1 and 2 show an example shaft fixing apparatus 100, according to an embodiment of the present disclosure. The fixing apparatus 100 can be utilized to fix a shaft 200 to a mounting part 300 (e.g., an outer shell or a bearing). The fixing apparatus 100 may include an inner ring 110 and an outer ring 120.

The inner ring 110 may have an outer tapered surface 111, as shown in FIG. 2. The inner ring 110 may be sleeved on the shaft 200. When the fixing apparatus 100 is in the unlocked state, the inner diameter of the inner ring 110 may be slightly larger than the outer diameter of the shaft 200 such that the inner ring 110 may be moved axially along the shaft 200. The outer ring 120 may have an inner tapered surface 121 that fits the outer tapered surface 111 of the inner ring 110. That is, the inner tapered surface 121 of the outer ring 120 may have substantially the same shape and size as the outer tapered surface 111 of the inner ring 110.

In some examples, when the inner ring 110 and the outer ring 120 are aligned in the axial direction, the inner diameter of the outer ring 120 may be slightly smaller than the outer diameter of the inner ring 110. In such examples, when the outer ring 120 is moved towards the mounting part 300 and both the inner ring 110 and the outer ring 120 abut the mounting part 300 in the axial direction (as shown in FIG. 1), the outer tapered surface 111 of the inner ring 110 may press against the inner tapered surface 121 of the outer ring 120. As a result, the inner ring 110 will compress under pressure to grip the shaft 200 in the radial direction, thereby locking the fixing apparatus 100 to the shaft.

In some aspects of the present disclosure, the outer ring 120 may be detachably fixed to the mounting part 300. For example, the fixing apparatus 100 may further include one or more screws 130 which can fix the outer ring 120 to the mounting part 300 in the axial direction. In other examples, the outer ring 120 may also be detachably fixed to the mounting part 300 in other suitable ways. In such examples as described above, when the outer ring 120 is fixed to the mounting part 300 and the inner ring 110 grips the shaft 200, the shaft 200 may thereby be fixed to the mounting part 300 through the fixing apparatus 100. The fixing apparatus 100 can be released by unmounting the outer ring 120 from the mounting part 300, such as by loosening the one or more screws 130 attaching the outer ring 120 to the mounting part 300.

The present disclosure provides for fixing the shaft 200 to the mounting part 300 with high mounting precision, high clamping forces and easy installation procedures.

In some embodiments, the outer tapered surface 111 of the inner ring 110 and the inner tapered surface 121 of the outer ring 120 may be threaded surfaces that correspond to each other. For example, the corresponding threaded surfaces enable the outer ring 120 to be screwed on the inner ring 110 to lock the shaft 200, or the outer ring 120 to be screwed off the inner ring 110 to unlock the shaft 200.

In some aspects of the present disclosure, the gripping force exerted on the shaft 200 by the fixing apparatus 100 can be adjusted by changing the material and/or geometry of the inner ring 110 and the outer ring 120. For example, the inner ring 110 may be made of plastic material. In such an example, the inner ring 110 may have a lighter clamping force because the plastic is easier to deform around the shaft 200. In other examples, the inner ring 110 may be alternatively made of a metal material, which may provide larger rigidity. In other examples, the inner ring 110 and outer ring 120 may be made of other suitable materials.

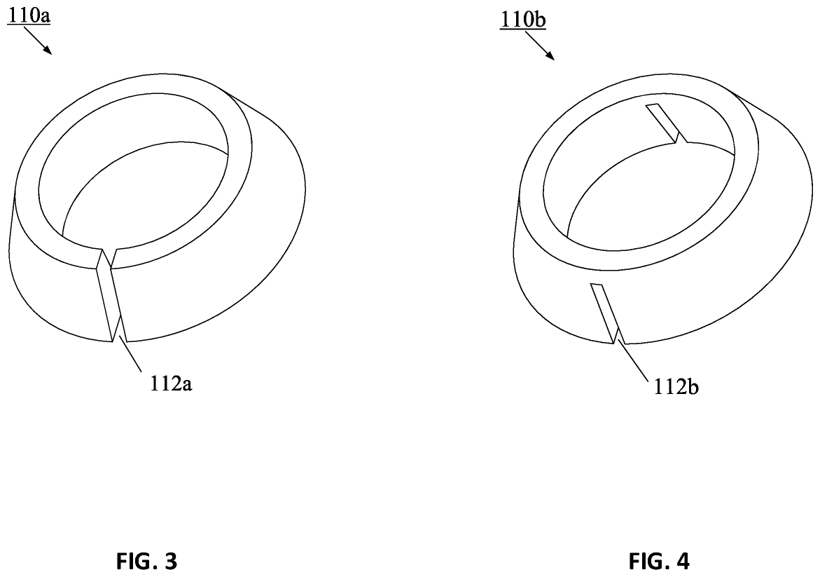

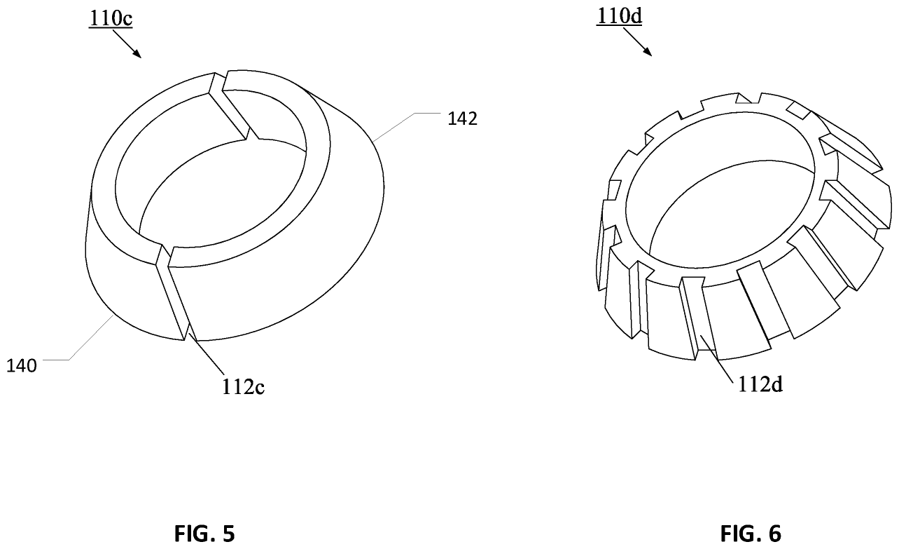

In some aspects, providing slots, or grooves, in the inner ring 110 may help to relieve stress caused by deformation of the inner ring 110, and thus improve the contact pressure between the inner ring 110, the outer ring 120 and the shaft 200. For example, exemplary designs of the inner ring 110 are shown in FIGS. 3-6. Specifically, FIG. 3 illustrates an example inner ring 110a that defines a groove 112a extending from one end surface to another end surface of the inner ring 110a. FIG. 4 illustrates an example inner ring 110b that defines a pair of grooves 112b extending from one end surface of the inner ring 110b to a certain depth. In some embodiments, as shown in FIG. 5, the example inner ring 110c may include two separated parts, for example, part 140 and part 142. In such embodiments, the two separated parts 140 and 142 may be sleeved on the shaft 200 and spaced apart in the circumferential direction to from a gap 112c which allows the inner ring 110c to deform in the circumferential direction.

In some embodiments, as shown in FIG. 6, the example inner ring 110d may define multiple grooves 112d that extend from one end surface to another end surface of the inner ring 110d such that the inner ring 110d may have a gear-shaped configuration. The groove(s) on the inner ring 110 as described in connection with FIGS. 3-6 may improve the deformability of the inner ring 110, and the improved deformability may allow the inner ring 110 to engage better with the outer ring 120 and the shaft 200. In other embodiments, the inner ring 110 may have other suitable designs for relieving stress in the inner ring 110 beyond those illustrated in FIGS. 3-6. In certain embodiments, a Morse taper may be used with the inner ring 110 to provide robust gripping contact.

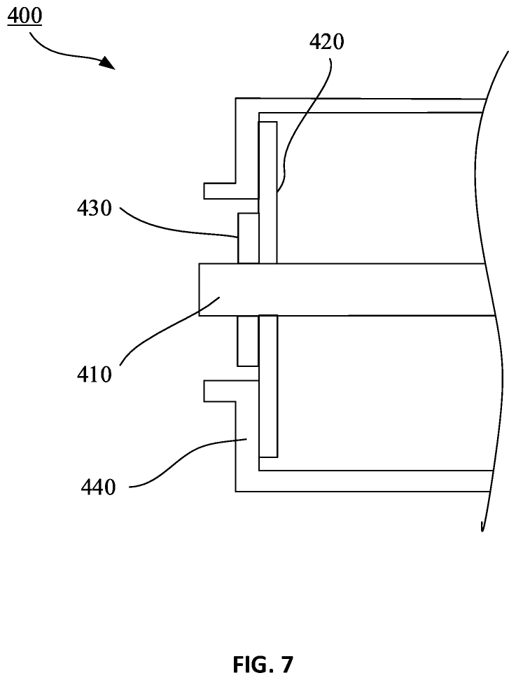

The present disclosure also provides for an actuator of a robot. The robot may be, for example, an industrial robot. The actuator may be included in the joint of the robot to drive the robot to move. As shown in FIG. 7, an example actuator 400 may include a shaft 410, a mounting part 420 and a fixing apparatus 430. The fixing apparatus 430 may be the fixing apparatus 100 as described above. The shaft 410 may be fixed to the mounting part 420 through the fixing apparatus 430.

In some embodiments, the mounting part 420 may be an end cover of the actuator 400. The actuator 400 may further include an outer enclosure 440. The end cover 420 may be installed inside and fixedly connected to the outer enclosure 440. In this example, the shaft 410 is also fixedly connected to the outer enclosure 440 such that the shaft 410 and the outer enclosure 440 cooperatively constitute a datum for aligning other components of the actuator 400. For example, the other components of the actuator 400 may include a motor assembly, a torque sensor, an output flange etc. These components may be connected to either the shaft 410 or the outer enclosure 440 for alignment.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A fixing apparatus for fixing a shaft to a mounting part, comprising:
an inner ring having an outer tapered surface, the inner ring configured to be sleeved on the shaft; and
an outer ring having an inner tapered surface, the inner tapered surface configured to fit the outer tapered surface of the inner ring,
wherein the inner ring and the outer ring are both configured to abut the mounting part in an axial direction of the shaft,
wherein the outer ring is configured to be detachably fixed to the mounting part, and
wherein the inner ring is squeezed by the outer ring to grip the shaft in a radial direction when the outer ring is fixed to the mounting part.

2. The fixing apparatus of claim 1, further comprising a screw configured to fix the outer ring to the mounting part in the axial direction.

3. The fixing apparatus of claim 1, wherein the inner ring comprises plastic material.

4. The fixing apparatus of claim 1, wherein the inner ring defines at least one groove which allows the inner ring to deform in a circumferential direction.

5. The fixing apparatus of claim 4, wherein
the at least one groove comprises a plurality of grooves extending from one end surface to another end surface of the inner ring such that the inner ring has a gear-shaped configuration.

6. The fixing apparatus of claim 1, wherein
the inner ring comprises two separated parts, and
wherein, when the two separated parts are sleeved on the shaft, the two separated parts are spaced apart in a circumferential direction to form a gap which allows the inner ring to deform in the circumferential direction.

7. The fixing apparatus of claim 1, wherein the outer tapered surface of the inner ring and the inner tapered surface of the outer ring are each threaded surfaces, and wherein the outer tapered threaded surface corresponds to the inner tapered threaded surface.

8. A fixing apparatus for fixing a shaft to a mounting part, comprising:
an inner ring having an outer tapered surface, the inner ring configured to be sleeved on the shaft; and
an outer ring having an inner tapered surface, the inner tapered surface configured to fit the outer tapered surface of the inner ring,
wherein the inner ring has an inner diameter originally smaller than an outer diameter of the shaft,
wherein, when the outer ring is moved towards the mounting part and both the inner ring and the outer ring abut the mounting part in an axial direction of the shaft, the inner tapered surface of the outer ring squeezes the outer tapered surface of the inner ring to make the inner ring compress and grip the shaft, and
wherein the outer ring is detachably fixed to the mounting part.

9. The fixing apparatus of claim 8, further comprising a screw configured to fix the outer ring to the mounting part in the axial direction.

10. The fixing apparatus of claim 8, wherein the outer tapered surface of the inner ring and the inner tapered surface of the outer ring are each threaded surfaces, and wherein the outer tapered threaded surface corresponds to the inner tapered threaded surface.

11. The fixing apparatus of claim 8, wherein the inner ring defines at least one groove which allows the inner ring to deform in a circumferential direction.

12. The fixing apparatus of claim 11, wherein
the at least one groove comprises a plurality of grooves extending from one end surface to another end surface of the inner ring such that the inner ring has a gear-shaped configuration.

13. The fixing apparatus of claim 8, wherein
the inner ring comprises two separated parts, and
wherein, when the two separated parts are sleeved on the shaft, the two separated parts are spaced apart in a circumferential direction to form a gap which allows the inner ring to deform in the circumferential direction.

14. An actuator of a robot comprising a shaft, a mounting part and a fixing apparatus configured to fix the shaft to the mounting part, wherein the fixing apparatus comprises:
an inner ring having an outer tapered surface, wherein the inner ring is sleeved on the shaft; and
an outer ring having an inner tapered surface, wherein the inner tapered surface fits the outer tapered surface of the inner ring,
wherein the inner ring and the outer ring both abut the mounting part in an axial direction of the shaft,
wherein the outer ring is detachably fixed to the mounting part, and
wherein the inner ring is squeezed by the outer ring to grip the shaft in a radial direction.

15. The actuator of claim 14, wherein the fixing apparatus further comprises a screw which fixes the outer ring to the mounting part in the axial direction.

16. The actuator of claim 14, wherein the inner ring defines at least one groove which allows the inner ring to deform in a circumferential direction.

17. The actuator of claim 16, wherein
the at least one groove comprises a plurality of grooves extending from one end surface to another end surface of the inner ring such that the inner ring has a gear-shaped configuration.

18. The actuator of claim 14, wherein
the inner ring comprises two separated parts, and
wherein the two separated parts are cooperatively sleeved on the shaft and spaced apart in a circumferential direction to form a gap which allows the inner ring to deform in the circumferential direction.

19. The actuator of claim 14, wherein the outer tapered surface of the inner ring and the inner tapered surface of the outer ring are each threaded surfaces, and wherein the outer tapered threaded surface corresponds to the inner tapered threaded surface.

20. The actuator of claim 14, further comprising an enclosure, wherein the mounting part is an end cover, and the shaft is fixedly connected to the enclosure through the fixing apparatus.
